(19) United States
(12) Patent Application Publication
(10) Pub. No.: US 2013/0061188 A1
(43) Pub. Date: Mar. 7, 2013

(54) Hierarchical Wafer Yield Predicting Method and Hierarchical Lifetime Predicting Method

(71) Applicants: Hsin-Ming Hou, Tai-Nan City (TW); Ji-Fu Kung, Taichung (TW)

(72) Inventors: Hsin-Ming Hou, Tai-Nan City (TW); Ji-Fu Kung, Taichung (TW)

(21) Appl. No.: 13/225,495

(22) Filed: Sep. 5, 2011

(51) Int. Cl. G06F 17/50

(52) U.S. Cl. 716/56

(57) ABSTRACT

For improving wafer fabrication, yield and lifetime of wafers are predicted by determining coefficients of a yield/lifetime domain, an integral domain, an electric/layout domain, a metrology/defect domain, and a machine sensor domain in a hierarchical manner. With the aid of the hierarchically-determined coefficients, noises in prediction can be reduced so that precision of prediction results of the yields or the lifetimes of wafers can be raised.

### BACKGROUND OF THE INVENTION

1. Field of the Invention

The present invention relates to a hierarchical wafer yield predicting method and a hierarchical lifetime predicting method, and more particularly, to a hierarchical wafer yield predicting method and a hierarchical lifetime predicting method both using a yield/lifetime domain, an integral domain, an electric/layout domain, a metrology/defect domain, and a machine sensor domain as different levels for prediction.

2. Description of the Prior Art

In conventional wafer fabrication, yield of fabricated wafers is highly monitored for improvements. Moreover, the yield may be predicted by observing data generated by fault detection and classification machine sensors which are responsible for detecting defects of the fabricated wafers.

However, there are several intermediate processes in wafer fabrication, and these intermediate processes may introduce large scales of noises in yield prediction. If these intermediate processes are highly correlative, or if these intermediate processes are performed as flat algorithms, the noises in the yield prediction will get worse.

### SUMMARY OF THE INVENTION

The claimed invention discloses a hierarchical wafer yield predicting method. The method comprises measuring a total yield of a plurality of wafers; determining a systematic yield and a random yield according to the total yield; determining at least one systematic integral value according to the systematic yield by using a 3-sigma binomial analysis; determining at least one systematic fault detection and classification value according to the at least one systematic integral value; determining a random integral value according to the random yield by using the 3-sigma binomial analysis; and determining a random fault detection and classification value according to the random integral value.

The claimed invention also discloses a hierarchical wafer lifetime predicting method. The method comprises measuring a total lifetime of a wafer; determining an intrinsic lifetime and an extrinsic lifetime according to the total lifetime; determining at least one extrinsic integral value according to the extrinsic lifetime by using a 3-sigma binomial analysis; determining at least one extrinsic fault detection and classification value according to the at least one extrinsic integral value; determining an intrinsic integral value according to the intrinsic lifetime by using the 3-sigma binomial analysis; and determining an intrinsic fault detection and classification value according to the intrinsic integral value.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a hierarchy utilized in the hierarchical wafer yield prediction method.

FIG. 2 illustrates a hierarchy utilized in a hierarchical wafer lifetime prediction method.

FIG. 3 illustrates a relation function between a lifetime of a wafer and a vary rate of the wafer.

FIG. 4 illustrates a flowchart of the hierarchical wafer yield predicting method of the present invention.

FIG. 5 illustrates a flowchart of the hierarchical wafer lifetime predicting method of the present invention.

### DETAILED DESCRIPTION

For raising precision in the yield prediction, the present invention discloses a hierarchical wafer yield predicting method. The hierarchical wafer yield predicting method utilizes five levels for discarding noises, where the five levels include a yield/lifetime domain, an integral domain, an electric/layout domain, a metrology/defect domain, and a machine sensor domain. The present invention further discloses a wafer lifetime prediction method based on the same hierarchy as the hierarchical wafer yield predicting method of the present invention.

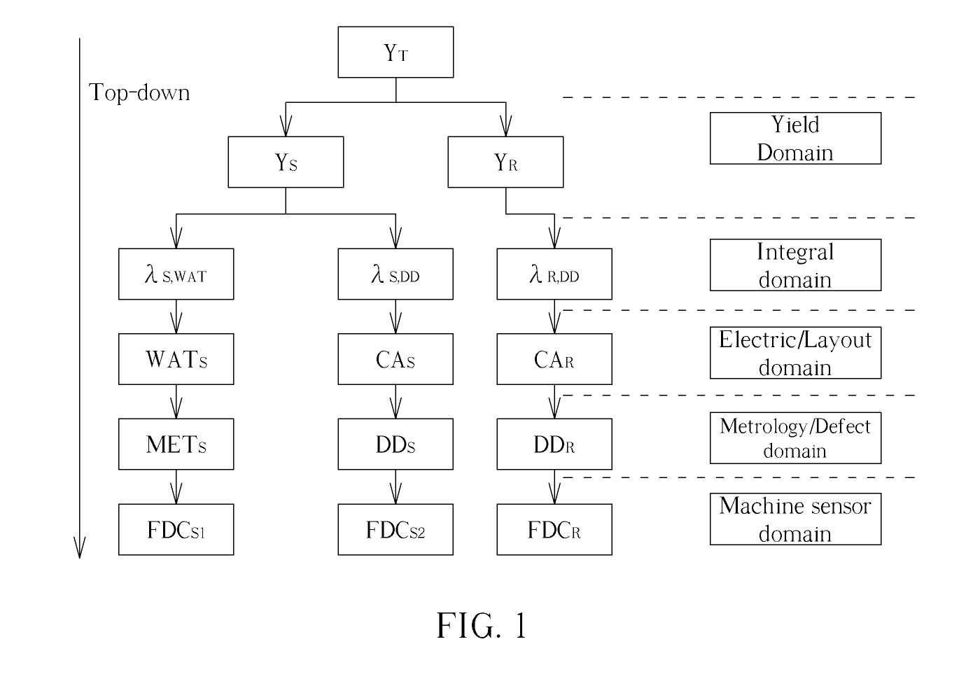

Please refer to FIG. 1, which illustrates a hierarchy utilized in the hierarchical wafer yield prediction method according to a first embodiment of the present invention.

### (a) Yield Domain

As shown in FIG. 1, a total yield Y_{T} of fabricated wafers is the first to be measured. A systematic yield Y_{S} and a random yield Y_{R} are then determined by differentiating systematic (or static) factors of the total yield Y_{T} from random factors of the total yield Y_{T}. Note that both the systematic yield Y_{S} and the random yield Y_{R} are assumed to belong to a yield domain, as shown in FIG. 1.

### (b) Integral Domain

The systematic yield Y_{S} is transformed into a systematic wafer acceptance test integral λ_{S,WAT} and a systematic defect density integral λ_{S,DD} by using a 3-sigma binomial analysis, which collects values within three standard deviations of a mean of a distribution indicated by either the systematic defect density integral λ_{S,DD} or the systematic defect density integral λ_{S,DD}. Note that most noises are not collected in the 3-sigma binomial analysis since they fall outside of the three standard deviations from the mean of said distribution, and most of the noises are discarded as a result.

Similarly, the random yield Y_{R} is also transformed into a random DD integral λ_{R,DD} by using the 3-sigma binomial analysis. The systematic defect density integral λ_{S,DD}, the systematic defect density integral λ_{S,DD}, and the random DD integral λ_{R,DD} are assumed to belong to an integral domain, as shown in FIG. 1.

### (c) Electric/Layout Domain, Metrology/Defect Domain, and Machine Sensor Domain

The electric/layout domain, the metrology/defect domain, and the machine sensor domain are performed under a principal component analysis (PCA) or a partial least square (PLS) analysis.

The PCA is used for figuring out dominant factors or variables among data. Therefore, with the aid of the PCA analysis, dominant causes of wafer defects will be determined.

The PLS analysis is used for determining correlations between factors. Therefore, with the aid of the PLS analysis, correlations between causes of wafer defects will be determined.

For clear descriptions, the integrals λ_{S,WAT}, λ_{S,DD} and λ_{R,DD} will be separately described.

(c-1) Systematic Wafer Acceptance Test Integral λ_{S,WAT}

The systematic wafer acceptance test integral λ_{S,WAT} is processed by a wafer acceptance test (WAT) based on the PCA or the PLS analysis, where the wafer acceptance test is utilized for examining defects on joint nodes between transistors on a wafer. Therefore, a plurality of WAT coefficients WAT_{S} belonging to the electric/layout domain can be determined.

The plurality of WAT coefficients WAT_{S} is then transformed into a plurality of metrology coefficients MET_{S} belonging to the metrology/defect domain, according to the fact that the systematic wafer acceptance test integral λ_{S,WAT} indicates an integral of the plurality of WAT coefficients WAT_{S} and the plurality of metrology coefficients MET_{S}.

Last, the plurality of metrology coefficients MET_{S} is transformed into a first plurality of systematic fault detection and classification (FDC) coefficients FDC_{S1} by using the PCA or the PLS analysis, where the fault detection and classification coefficients are to indicate the prediction result of causes of wafer defects. Note that the first plurality of systematic FDC coefficients FDC_{S1} belongs to the machine sensor domain.

(c-2) Systematic Defect Density Integral λ_{S,DD}

The systematic defect density integral λ_{S,DD} is processed by using the PCA or the PLS analysis to determine a plurality of systematic critical area coefficients CA_{S} belonging to the electric/layout domain.

The plurality of systematic critical area coefficients CA_{S} is then transformed into a plurality of systematic density defect (DD) coefficients DD_{S} belonging to the metrology/defect domain, according to the fact that the systematic DD integral λ_{S,DD} indicates an integral of the plurality of systematic critical area coefficients CA_{S} and the plurality of systematic DD coefficients DD_{S}.

Similarly, the plurality of systematic DD coefficients DD_{S} is transformed into a second plurality of systematic FDC coefficients FDC_{S2} by using the PCA or the PLS analysis. Note that the second plurality of systematic FDC coefficients FDC_{S2} belongs to the machine sensor domain.

(c-3) Random Defect Density Integral λ_{R,DD}

The random defect density integral λ_{R,DD} is processed by the PCA or the PLS analysis to determine a plurality of random critical area coefficients CA_{R} belonging to the electric/layout domain.

The plurality of random critical area coefficients CA_{R} is then transformed into a plurality of random DD coefficients DD_{R} belonging to the metrology/defect domain, according to the fact that the random DD integral λ_{R,DD} indicates an integral of the plurality of random critical area coefficients CA_{R} and the plurality of random DD coefficients DD_{R}.

Similarly, the plurality of random DD coefficients DD_{R} is transformed into a plurality of random FDC coefficients FDC_{R} by using the PCA or the PLS analysis. Note that the plurality of random FDC coefficients FDC_{R} belongs to the machine sensor domain.

After retrieving the plurality of first and second systematic FDC coefficients FDC_{S1}, FDC_{S2} and the plurality of random FDC coefficients FDC_{R}, a profile of yield prediction of wafers can be fulfilled, so as to improve the yield of wafer fabrication.

The hierarchy shown in FIG. 1 is performed level-by-level and in a top-down manner.

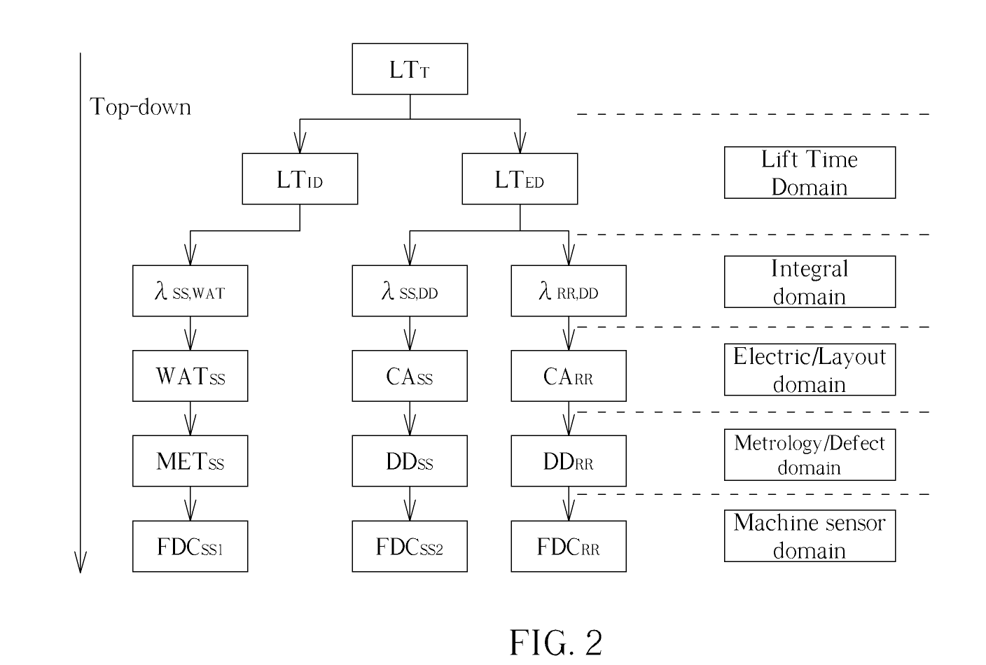

Besides yield prediction, the hierarchy shown in FIG. 1 may also be used for predicting lifetimes of transistors on a wafer or a wafer, according to an embodiment of the present invention. Please refer to FIG. 2, which illustrates a hierarchy utilized in a hierarchical wafer lifetime prediction method according to a second embodiment of the present invention.

### (d) Lifetime Domain

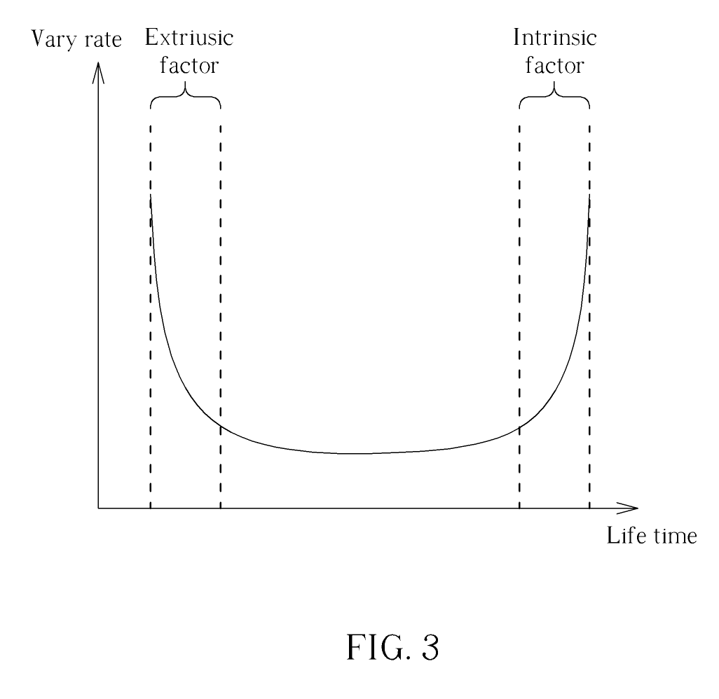

As shown in FIG. 2, a total lifetime LT_{T} of fabricated wafers is the first to be measured. An intrinsic lifetime LT_{ID} and an extrinsic lifetime LT_{ED} are then determined by differentiating intrinsic factors of the total lifetime L_{TT} from extrinsic factors of the total lifetime LT_{T}, where the intrinsic lifetime LT_{ID} is determined according to the intrinsic factors of the total lifetime L_{TT}, and the extrinsic lifetime LT_{ED} is determined according to the extrinsic factors of the total lifetime L_{TT}. Similarly with the yield case, both the intrinsic lifetime LT_{ID} and the extrinsic lifetime LT_{ED} are assumed to belong to a lifetime domain, as shown in FIG. 2. Please refer to FIG. 3, which illustrates a relation function between a lifetime of a wafer and a vary rate of the wafer. FIG. 3 is utilized for indicating the intrinsic factor and the extrinsic factor of the lifetime, where the relation function forms a normal distribution, the intrinsic factor corresponds to longer lifetimes of the wafer, and the extrinsic factor corresponds to shorter lifetimes of the wafer.

### (e) Integral Domain

The intrinsic lifetime LT_{ID} is transformed into a systematic WAT integral λ_{SS,WAT} by using the 3-sigma binomial analysis so as to collect values within three standard deviations of a mean of a distribution indicated by the systematic WAT integral λ_{SS,WAT}.

The extrinsic lifetime LT_{ED} is also transformed into a systematic defect density (DD) integral λ_{SS,DD} and a random DD integral λ_{RR,DD} by using the 3-sigma binomial analysis.

The systematic WAT integral λ_{SS,WAT}, the systematic DD integral λ_{SS,DD}, and the random DD integral λ_{RR,DD} are assumed to belong to an integral domain, as shown in FIG. 2.

### (f) Electric/Layout Domain, Metrology/Defect Domain, and Machine Sensor Domain

The electric/layout domain, the metrology/defect domain, and the machine sensor domain are performed under the PCA or the PLS analysis.

Similarly with the yield case, the integrals λ_{SS,WAT}, λ_{SS,DD} and λ_{RR,DD} will be separately described.

(f-1) Systematic Wafer Acceptance Test Integral λ_{SS,WAT}

The systematic WAT integral λ_{SS,WAT} is processed by the WAT based on the PCA or the PLS analysis. Therefore, a plurality of WAT coefficients WAT_{SS} belonging to the electric/layout domain can be determined.

The plurality of WAT coefficients WAT_{SS} is then transformed into a plurality of metrology coefficients MET_{SS} belonging to the metrology/defect domain, according to the fact that the systematic wafer acceptance test integral λ_{SS,WAT} indicates an integral of the plurality of WAT coefficients WAT_{SS} and the plurality of metrology coefficients MET_{SS}.

Last, the plurality of metrology coefficients MET_{SS} is transformed into a first plurality of systematic FDC coefficients FDC_{SS1} by using the PCA or the PLS analysis. Note that the first plurality of systematic FDC coefficients FDC_{SS1} belongs to the machine sensor domain.

(f-2) Systematic Defect Density Integral λ_{SS,DD}

The systematic defect density integral λ_{SS,DD} is processed by the PCA or the PLS analysis to determine a plurality of systematic critical area coefficients CA_{SS} belonging to the electric/layout domain.

The plurality of systematic critical area coefficients CA_{SS} is then transformed into a plurality of systematic density defect (DD) coefficients DD_{SS} belonging to the metrology/defect domain, according to the fact that the systematic DD integral λ_{SS,DD} indicates an integral of the plurality of systematic critical area coefficients CA_{SS} and the plurality of systematic DD coefficients DD_{SS}.

Similarly, the plurality of systematic DD coefficients is transformed into a second plurality of systematic FDC coefficients FDC_{SS2} by using the PCA or the PLS analysis. Note that the second plurality of systematic FDC coefficients FDC_{SS2} belongs to the machine sensor domain.

(f-3) Random Defect Density Integral λ_{RR,DD}

The random DD integral λ_{RR,DD} is performed with the PCA or the PLS analysis to determine a plurality of random critical area coefficients CA_{RR} belonging to the electric/layout domain.

The plurality of random critical area coefficients CA_{RR} is then transformed into a plurality of random DD coefficients DD_{RR} belonging to the metrology/defect domain, according to the fact that the random DD integral λ_{RR,DD} indicates an integral of the plurality of random critical area coefficients CA_{RR} and the plurality of random DD coefficients DD_{RR}.

The plurality of random DD coefficients DD_{RR} is transformed into a plurality of random FDC coefficients FDC_{RR} by using the PCA or the PLS analysis. Note that the plurality of random FDC coefficients FDC_{RR} belongs to the machine sensor domain.

After retrieving the plurality of first and second systematic FDC coefficients FDC_{SS1}, FDC_{SS2} and the plurality of random FDC coefficients FDC_{RR}, a profile of lifetime prediction of wafers can be fulfilled for improving the wafer fabrication.

Similar with the yield case, the hierarchy shown in FIG. 2 is performed level-by-level and in a top-down manner.

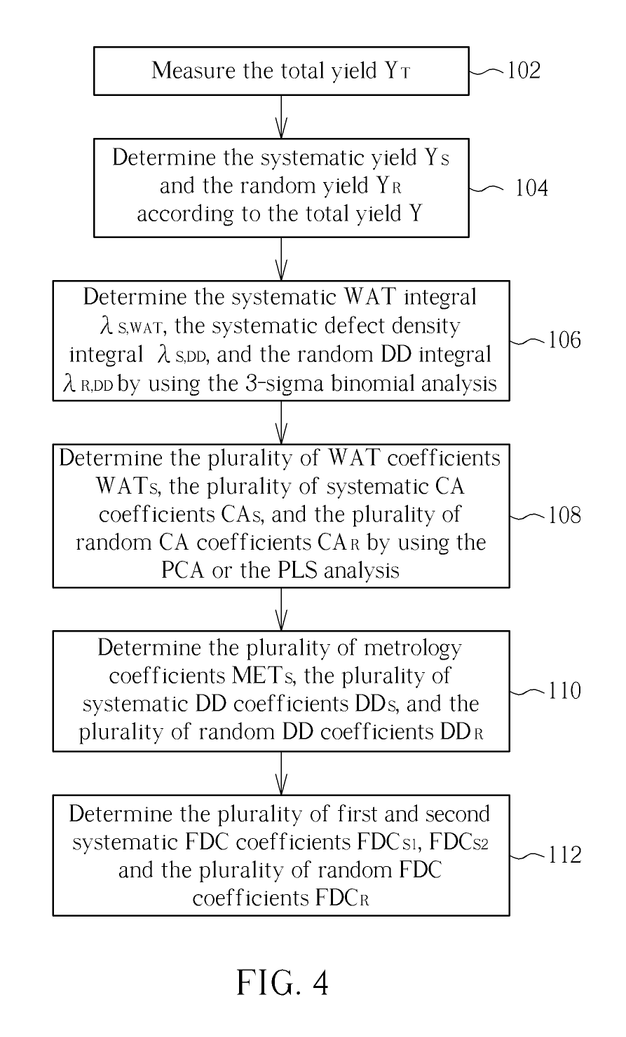

Please refer to FIG. 4, which illustrates a flowchart of the hierarchical wafer yield predicting method according to the first embodiment of the present invention.

Step 102: Measure the total yield Y_{T};

Step 104: Determine the systematic yield Y_{S} and the random yield Y_{R} according to the total yield Y_{T};

Step 106: Determine the systematic WAT integral λ_{S,WAT}, the systematic defect density integral λ_{S,DD}, and the random DD integral λ_{R,DD} by using the 3-sigma binomial analysis.

Step 108: Determine the plurality of WAT coefficients WAT_{S}, the plurality of systematic CA coefficients CA_{S}, and the plurality of random CA coefficients CA_{R} by using the PCA or the PLS analysis;

Step 110: Determine the plurality of metrology coefficients MET_{S}, the plurality of systematic DD coefficients DD_{S}, and the plurality of random DD coefficients DD_{R};

Step 112: Determine the plurality of first and second systematic FDC coefficients FDC_{S1}, FDC_{S2} and the plurality of random FDC coefficients FDC_{R}.

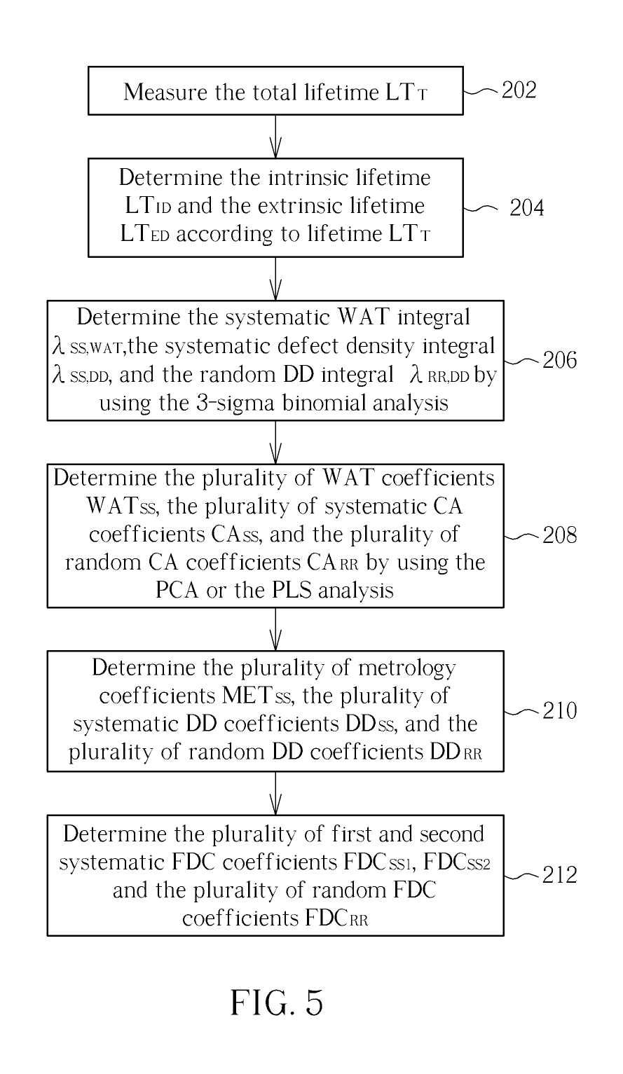

Please also refer to FIG. 5, which illustrates a flowchart of the hierarchical wafer lifetime predicting method according to the second embodiment of the present invention.

Step 202: Measure the total lifetime LT_{T};

Step 204: Determine the intrinsic lifetime LT_{ID} and the extrinsic lifetime LT_{ED} according to lifetime LT_{T};

Step 206: Determine the systematic WAT integral λ_{SS,WAT}, the systematic defect density integral λ_{SS,DD}, and the random DD integral λ_{RR,DD} by using the 3-sigma binomial analysis;

Step 208: Determine the plurality of WAT coefficients WAT_{SS}, the plurality of systematic CA coefficients CA_{SS}, and the plurality of random CA coefficients CA_{RR} by using the PCA or the PLS analysis;

Step 210: Determine the plurality of metrology coefficients MET_{SS}, the plurality of systematic DD coefficients DD_{SS}, and the plurality of random DD coefficients DD_{RR};

Step 212: Determine the plurality of first and second systematic FDC coefficients FDC_{SS1}, FDC_{SS2} and the plurality of random FDC coefficients FDC_{RR}.

FIGS. 4-5 indicate a summary of performing the hierarchies shown in FIGS. 1-2 for predicting the yield or the lifetime of wafers. However, embodiments formed by reasonable combinations and/or permutations of the flowcharts shown in FIG. 4 or FIG. 5, or by adding the above-mentioned limitations, should also be regarded as embodiments of the present invention.

The present invention discloses a hierarchical wafer yield predicting method and a hierarchical wafer lifetime predicting method for discarding noises in prediction. In both the methods, coefficients of a yield/lifetime domain, an integral domain, an electric/layout domain, a metrology/defect domain, and a machine sensor domain are determined in a hierarchical manner. With the aid of the hierarchically-determined coefficients, noises in prediction can be reduced so that precision of prediction results of the yields or the lifetimes of wafers can be raised.

Those skilled in the art will readily observe that numerous modifications and alterations of the device and method may be made while retaining the teachings of the invention.

1. A hierarchical wafer yield predicting method comprising:
measuring a total yield of a plurality of wafers;
determining a systematic yield and a random yield according to the total yield;
determining at least one systematic integral value according to the systematic yield by using a 3-sigma binomial analysis;
determining at least one systematic fault detection and classification value according to the at least one systematic integral value;
determining a random integral value according to the random yield by using the 3-sigma binomial analysis; and
determining a random fault detection and classification value according to the random integral value.

2. The method of claim 1 wherein determining the at least one systematic fault detection and classification value according to the at least one systematic integral value is determining the at least one systematic fault detection and classification value according to the at least one systematic integral value by using a principal component analysis and a partial least square analysis.

3. The method of claim 2 wherein determining the at least one systematic integral value according to the systematic yield is determining a systematic WAT (wafer acceptance test) integral value and a systematic DD (defect density) integral value according to the systematic yield.

4. The method of claim 3 wherein determining the at least one systematic fault detection and classification value according to the at least one systematic integral value is determining a first systematic fault detection and classification value according to the systematic WAT integral value and determining a second systematic fault detection and classification value according to the systematic DD integral value.

5. The method of claim 4 wherein determining the first systematic fault detection and classification value according to the systematic WAT integral value comprises:
determining a WAT coefficient according to the systematic WAT integral value;
determining a metrology coefficient according to the WAT coefficient; and
determining the first systematic fault detection and classification value according to the metrology coefficient;
wherein the systematic WAT integral value indicates an integral of the metrology coefficient and the WAT coefficient.

6. The method of claim 4 wherein determining the second systematic fault detection and classification value according to the systematic DD integral value comprises:
determining a systematic critical area coefficient according to the systematic DD integral value;
determining a systematic DD coefficient according to the systematic critical area coefficient; and
determining the second systematic fault detection and classification value according to the systematic DD coefficient;
wherein the systematic DD integral value indicates an integral of the systematic critical area coefficient and the systematic DD coefficient.

7. The method of claim 1 wherein determining the random fault detection and classification value according to the random integral value is determining the random fault detection and classification value according to the random integral value by using a principal component analysis and a partial least square analysis.

8. The method of claim 7 wherein determining the random fault detection and classification value according to the random integral value comprises:
determining a random critical area coefficient according to the random integral value;
determining a random DD coefficient according to the random critical area coefficient; and
determining the random fault detection and classification value according to the random DD coefficient;
wherein the random integral value indicates an integral of the random critical area coefficient and the random DD coefficient.

9. A hierarchical wafer lifetime predicting method comprising:
measuring a total lifetime of a wafer;
determining an intrinsic lifetime and an extrinsic lifetime according to the total lifetime;
determining at least one extrinsic integral value according to the extrinsic lifetime by using a 3-sigma binomial analysis;
determining at least one extrinsic fault detection and classification value according to the at least one extrinsic integral value;
determining an intrinsic integral value according to the intrinsic lifetime by using the 3-sigma binomial analysis; and
determining an intrinsic fault detection and classification value according to the intrinsic integral value.

10. The method of claim 9 wherein determining the at least one extrinsic fault detection and classification value according to the at least one extrinsic integral value is determining the at least one extrinsic fault detection and classification value according to the at least one extrinsic integral value by using a principal component analysis and a partial least square analysis.

11. The method of claim 10 wherein determining the at least one extrinsic integral value according to the extrinsic lifetime is determining a systematic DD integral value and a random DD integral value according to the extrinsic lifetime.

12. The method of claim 11 wherein determining the at least one extrinsic fault detection and classification value according to the at least one extrinsic integral value is determining a first extrinsic fault detection and classification value according to the systematic DD integral value and determining a second extrinsic fault detection and classification value according to the random DD integral value.

13. The method of claim 12 wherein determining the first extrinsic fault detection and classification value according to the systematic DD integral value comprises:
determining a systematic critical area coefficient according to the systematic DD integral value;
determining a systematic DD coefficient according to the systematic critical area coefficient; and
determining the first extrinsic fault detection and classification value according to the systematic DD coefficient;
wherein the systematic DD integral value indicates an integral of the systematic critical area coefficient and the systematic DD coefficient.

14. The method of claim 12 wherein determining the second extrinsic fault detection and classification value according to the random DD integral value comprises:
determining a random critical area coefficient according to the random DD integral value;
determining a random DD coefficient according to the random critical area coefficient; and
determining the second extrinsic fault detection and classification value according to the random DD coefficient;
wherein the random DD integral value indicates an integral of the random critical area coefficient and the random DD coefficient.

15. The method of claim 9 wherein determining the intrinsic fault detection and classification value according to the intrinsic integral value is determining the intrinsic fault detection and classification value according to the intrinsic integral value by using a principal component analysis and a partial least square analysis.

16. The method of claim 15 wherein determining the intrinsic fault detection and classification value according to the intrinsic integral value comprises:
determining a WAT coefficient according to the intrinsic integral value;
determining a metrology coefficient according to the WAT coefficient; and
determining the intrinsic fault detection and classification value according to the metrology coefficient;
wherein the intrinsic integral value indicates an integral of the WAT coefficient and the metrology coefficient.
